(19) United States
(12) Patent Application Publication
(10) Pub. No.: US 2007/0025213 A1
(43) Pub. Date: Feb. 1, 2007

(54) Information reproducing apparatus and information reproducing method

(75) Inventors: Hiroaki Morino, Yokohama-Shi (JP); Toshihiko Kaneshige, Yokohama-Shi (JP); Koichi Otake, Yokohama-Shi (JP); Hideyuki Yamakawa, Kawasaki-Shi (JP); Yukiyasu Tatsuzawa, Yokohama-Shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/493,793

(22) Filed: Jul. 27, 2006

(30) Foreign Application Priority Data
Jul. 28, 2005 (JP) 2005-219614

(51) Int. Cl. G11B 15/52

(52) U.S. Cl. 369/52.1

(57) ABSTRACT

An information reproducing apparatus according to the present invention is capable of reproducing an information storage medium storing BCA information recorded in a first area and RF information recorded in a second area on an outer side of the first area. The information reproducing apparatus includes an optical pickup to radiate laser light onto the first and second areas and detect reflected light thereof; a reproducing system unit to reproduce an RF signal and a BCA signal on the basis of the reflected light; and a focus control unit to control focusing by setting a focus position to a signal layer of the optical disc when the RF signal is to be reproduced and control defocusing by displacing the focus position from the signal layer when the BCA signal is to be reproduced, thereby equivalently suppressing a high-frequency component of the BCA signal.

### BACKGROUND OF THE INVENTION

1. Field of the Invention

The present invention relates to an information reproducing apparatus and an information reproducing method and particularly to an information reproducing apparatus and an information reproducing method for reproducing information recorded on an optical disc or the like.

2. Description of the Related Art

An information storage medium, such as an optical disc, conventionally has a special area called BCA (Burst Cutting Area), as well as a user area to store user data including video and audio data and various information data.

The BCA is provided on a recording surface of an optical disc and is made by barcode cutting or application of a coloring agent. The BCA is a ring-shaped area having a very small width of several millimeters and is provided at part of the inner periphery side of the optical disc.

Information important for appropriately reproducing the optical disc, such as the type or identification information of the optical disc, is recorded in the BCA. Thus, the density of information recorded in the BCA is different from that in a normal user area so that the information can be reliably read from the BCA.

Specifically, information is recorded on pits on tracks in the user area. On the other hand, in the BCA, a reflective film made of aluminum foil or the like on the inner periphery side of the disc is cut in a stripe pattern by a laser or the like in a radius direction of the disc, and the stripes arranged along the innermost periphery of the disc serve as barcode signals.

Typically, a pitch of the stripes of the barcode recorded in the BCA is larger than that of the pits in the user area. Thus, the frequency band of a signal obtained from the BCA during rotation of the disc (hereinafter referred to as a BCA signal) is lower than that of a signal obtained from the user area (hereinafter referred to as an RF signal).

A BCA signal superimposed on an RF signal may be output from a pickup. Therefore, in order to correctly reproduce the signals without the BCA signal being wrongly detected due to an effect of the RF signal, the BCA signal and the RF signal need to be processed individually.

For example, JP 11-328857 A discloses a technique of binarizing a BCA signal and determining the BCA signal by using a pulse width of the binarized signal so that a low-pass filter, which has conventionally been used in many cases, is unnecessary.

JP 10-198965 A also discloses a technique of peak-holding a BCA signal superimposed with an RF signal, removing a high-frequency component from the peak-held signal by using a low-pass filter, and then binarizing the signal at a predetermined threshold so as to read the BCA signal.

As described above, the frequency band of a BCA signal is lower than that of an RF signal. Therefore, a low-pass filter to allow a low-frequency component to pass therethrough is required to reproduce the BCA signal.

On the other hand, the frequency band of an RF signal is higher than that of a BCA signal and thus a low-pass filter is not required.

Accordingly, in the known art, two reproducing systems for BCA signals and RF signals are provided in parallel in many cases, which causes the hardware scale to become large and inhibits miniaturization and reduction in weight and cost.

### SUMMARY OF THE INVENTION

The present invention has been made in view of the above-described circumstances and is directed to providing an information reproducing apparatus and an information reproducing method capable of reproducing BCA and RF signals with a smaller hardware scale.

According to an aspect of the present invention, there is provided an information reproducing apparatus capable of reproducing an information storage medium storing BCA information recorded in a first area and RF information recorded in a second area on an outer side of the first area. The information reproducing apparatus includes an optical pickup to radiate laser light onto the first and second areas of the information storage medium and detect reflected light thereof; a reproducing system unit to reproduce an RF signal and a BCA signal on the basis of the reflected light detected by the optical pickup; and a focus control unit to control focusing by setting a focus position of the optical pickup to a signal layer of the optical disc when the RF signal is to be reproduced and control defocusing by displacing the focus position of the optical pickup from the signal layer when the BCA signal is to be reproduced, thereby equivalently suppressing a high-frequency component of the BCA signal.

According to another aspect of the present invention, there is provided an information reproducing method capable of reproducing an information storage medium storing BCA information recorded in a first area and RF information recorded in a second area on an outer side of the first area. The information reproducing method includes a step of radiating laser light onto the first and second areas of the information storage medium and detecting reflected light thereof by an optical pickup; a reproducing step of reproducing an RF signal and a BCA signal on the basis of the reflected light detected by the optical pickup; and a focus control step of controlling focusing by setting a focus position of the optical pickup to a signal layer of the optical disc when the RF signal is to be reproduced and controlling defocusing by displacing the focus position of the optical pickup from the signal layer when the BCA signal is to be reproduced, thereby equivalently suppressing a high-frequency component of the BCA signal.

According to the information reproducing apparatus and the information reproducing method, BCA and RF signals can be reproduced with a smaller hardware scale.

### BRIEF DESCRIPTION OF THE DRAWINGS

FIG. 1 shows an example of a system configuration of an information reproducing apparatus according to an embodiment of the present invention;

FIG. 2 is a flowchart showing an example of an operation performed by the information reproducing apparatus;

FIGS. 3A and 3B are first illustration diagrams showing a concept of defocus control in the information reproducing apparatus;

FIGS. 4A and 4B are second illustration diagrams showing a concept of defocus control in the information reproducing apparatus;

FIG. 5 is a flowchart showing an example of an operation according to another embodiment performed by the information reproducing apparatus;

FIG. 6 shows an example of a system configuration of a known information reproducing apparatus; and

FIG. 7 is a flowchart showing an example of an operation performed by the known information reproducing apparatus.

### DESCRIPTION OF THE PREFERRED EMBODIMENTS

Hereinafter, an information reproducing apparatus and an information reproducing method according to an embodiment of the present invention are described with reference to the attached drawings.

(1) Configuration

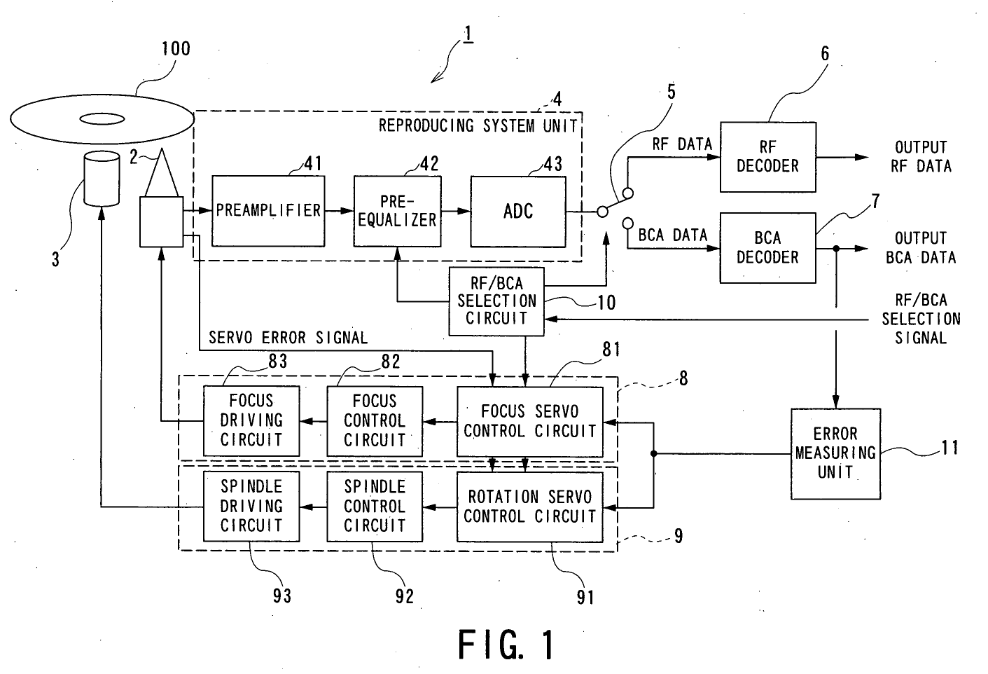

FIG. 1 shows an example of a system configuration of an information reproducing apparatus 1 according to an embodiment of the present invention.

The information reproducing apparatus 1 includes an optical pickup 2 to read information recorded on an optical disc 100; a spindle motor 3 to drive and rotate the optical disc 100; a reproducing system unit 4 to process BCA and RF signals output from the optical pickup 2 and convert the signals to digital signals; a switch 5 to switch between the digitalized BCA signal and RF signal (called BCA data and RF data, respectively); an RF decoder 6 to decode the RF data; and a BCA decoder 7 to decode the BCA data.

Also, the information reproducing apparatus 1 includes an RF/BCA selection circuit 10 to generate a control signal on the basis of an RF/BCA selection signal to select reproducing of an RF signal or a BCA signal; a focus control unit 8 to control focusing of the optical pickup 2 on the basis of a servo error signal output from the optical pickup 2 and the control signal output from the RF/BCA selection circuit 10; and a rotation control unit 9 to control rotation driving of the spindle motor 3.

The information reproducing apparatus 1 may further include an error measuring unit 11 to measure a symbol error rate of a BCA signal.

The optical disc 100 is a conventional DVD or a next-generation HD DVD and includes at least the following two areas: a user area to store video and audio data and various information processing data; and a burst cutting area (BCA) to store the type and identification information of the disc.

In the user area, pits are formed on tracks and data is recorded with the pits. On the other hand, in the BCA, stripes are formed by cutting a reflective film made of aluminum foil or the like, the reflective film being formed on the inner periphery side of the disc, in a radius direction by using a laser or the like. These stripes are arranged along the innermost periphery of the disc and serve as barcode signals.

Typically, the pitch of the stripes of the barcode recorded in the BCA is larger than that of the pits in the user area. Therefore, the frequency band of a signal obtained from the BCA during rotation of the disc (hereinafter referred to as a BCA signal) is lower than that of a signal obtained from the user area (hereinafter referred to as an RF signal).

The optical pickup 2 reads information recorded on the optical disc 100. More specifically, the optical pickup 2 radiates laser light onto a signal layer (recording surface) of the optical disc 100 and reads recorded information through a change in intensity of reflected light thereof. A signal output from the optical pickup 2 is usually called an RF signal. In this case, however, a signal obtained when the optical pickup 2 is positioned in the user area is called an RF signal, whereas a signal obtained when the optical pickup 2 is positioned in the BCA is called a BCA signal.

The optical pickup 2 is movable in a diameter direction of the optical disc 100 by a predetermined driving mechanism (not shown). Also, the optical pickup 2 is movable in a thickness direction of the optical disc 100 so that laser light is focused on the signal layer of the optical disc 100. Position control in the thickness direction is called focus control.

The optical pickup 2 outputs not only the RF and BCA signals but also a track error signal, which is an error between a spot of laser light and a track position, and a focus error signal, which is an error of a focus position. Servo control is performed by using these error signals, and thus these error signals are called servo error signals.

A focus position of the optical pickup 2 is controlled on the basis of a control signal from the focus control unit 8. The focus control unit 8 includes a focus servo control circuit 81, a focus control circuit 82, and a focus driving circuit 83.

When an RF signal is to be read from the user area, the focus servo control circuit 81 performs servo control by using a focus error signal output from the optical pickup 2, and an output from the focus servo control circuit 81 is applied to the driving mechanism inside the optical pickup 2 via the focus control circuit 82 and the focus driving circuit 83. This servo loop allows a focus position to constantly be positioned on the signal layer of the optical disc 100.

On the other hand, when a BCA signal is to be read from the BCA, a focus position is displaced from the signal layer (defocusing), as described below.

Rotation control of the spindle motor 3 is performed on the basis of a control signal from the rotation control unit 9. The rotation control unit 9 includes a rotation servo control circuit 91, a spindle control circuit 92, and a spindle driving circuit 93. The rotation servo control circuit 91 performs servo control on the basis of a servo error signal obtained from the optical pickup 2 so that a predetermined rotation speed can be obtained, and controls rotation of the spindle motor 3 via the spindle control circuit 92 and the spindle driving circuit 93.

The RF and BCA signals output from the optical pickup 2 are input to the reproducing system unit 4. The reproducing system unit 4 includes a preamplifier 41, a pre-equalizer 42, and an ADC 43.

The preamplifier 41 performs predetermined gain control on the RF and BCA signals output form the optical pickup 2.

The pre-equalizer 42 performs waveform equalization on the RF and BCA signals. The frequency band of the RF signal is different from that of the BCA signal, and thus the waveforms thereof are different from each other. Therefore, waveform equalization appropriate for the respective signal waveforms is performed on the basis of a control signal from the RF/BCA selection circuit 10.

RF data and BCA data generated through conversion from analog signals to digital signals by the ADC 43 are input to the RF decoder 6 and the BCA decoder 7, respectively, through the switch 5.

The switch 5 is switched on the basis of a control signal from the RF/BCA selection circuit 10. More specifically, the switch 5 is selectively switched to a path on the RF decoder 6 side when an RF signal in the user area is reproduced or to a path on the BCA decoder 7 side when a BCA signal in the BCA is reproduced.

The RF data and the BCA data are encoded with an appropriate error correction code, and thus are decoded by the RF decoder 6 and the BCA decoder 7, respectively, so as to be used as reproduced data.

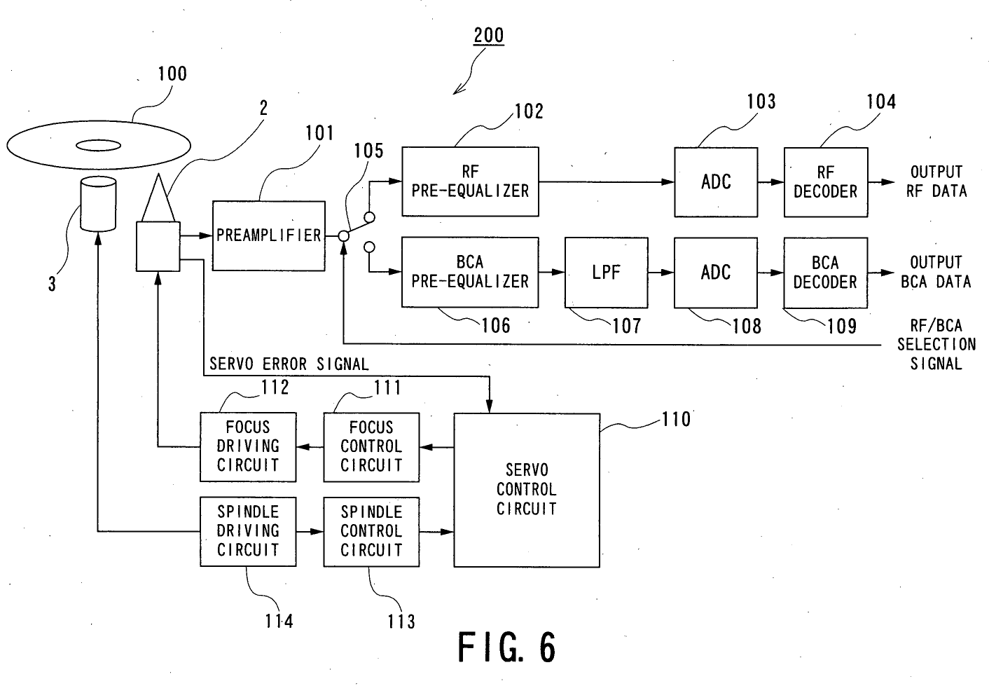

FIG. 6 shows a system configuration of a known information reproducing apparatus 200, which is a comparative example used to compare the information reproducing apparatus 1 according to the embodiment of the present invention with the known information reproducing apparatus 200.

In the known information reproducing apparatus 200, RF and BCA signals output from an optical pickup 2 pass through a preamplifier 101 and are then supplied to one of two systems by a switch 105, so that those signals are processed in different reproducing systems.

The system to reproduce the BCA signal includes a low-pass filter 107, which is placed between a BCA pre-equalizer 106 and an ADC 108. The frequency band of the BCA signal is lower than that of the RF signal. Use of the low-pass filter 107 can prevent mixing of the RF signal and remove unnecessary noise having a high frequency component.

On the other hand, the frequency band of the RF signal is high and thus a high-frequency component needs to be passed. For this reason, the system for the RF signal does not have a low-pass filter.

The differences between the system configuration according to the embodiment shown in FIG. 1 and that of the known art are as follows. Firstly, a low-pass filter is not used in the embodiment. Secondly, waveform equalization performed by the pre-equalizer 42 is switched by an externally-supplied control signal, so that the pre-equalizer 42 can be shared by both RF and BCA signals. As a result, the two reproducing systems in the known art can be unified, so that the single reproducing system unit 4 can process both RF and BCA signals. Accordingly, the hardware scale can be reduced.

(2) Operation

An operation of the information reproducing apparatus 1 having the above-described configuration is further described below, particularly about an operation of reproducing the BCA signal.

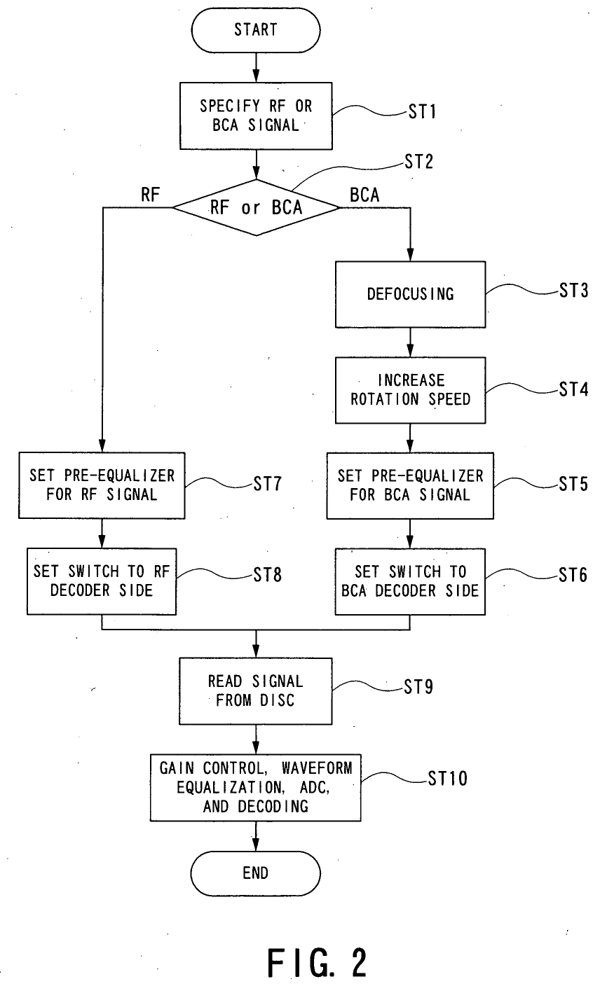

FIG. 2 is a flowchart showing an example of a reproducing operation performed in the information reproducing apparatus 1. First, a signal to be reproduced, that is, an RF signal or a BCA signal is specified in step ST1.

When an RF signal is to be reproduced (“RF” in step ST2), a circuit constant is set so that the pre-equalizer 42 performs waveform equalization adaptive to the waveform of the RF signal (step ST7). Further, the switch 5 is set to the RF decoder 6 side (step ST8). The setting is performed on the basis of a control signal from the RF/BCA selection circuit 10.

After the setting, the optical pickup 2 reads an RF signal from the optical disc 100 (step ST9), gain control, waveform equalization, and AD conversion are performed on the read RF signal, and the RF signal is decoded by the RF decoder 6, so that a reproduced output signal is obtained (step ST10).

When a BCA signal is to be reproduced, a focus position of the optical pickup 2 is displaced to the inner side in the thickness direction of the optical disc 100 for defocusing (step ST3).

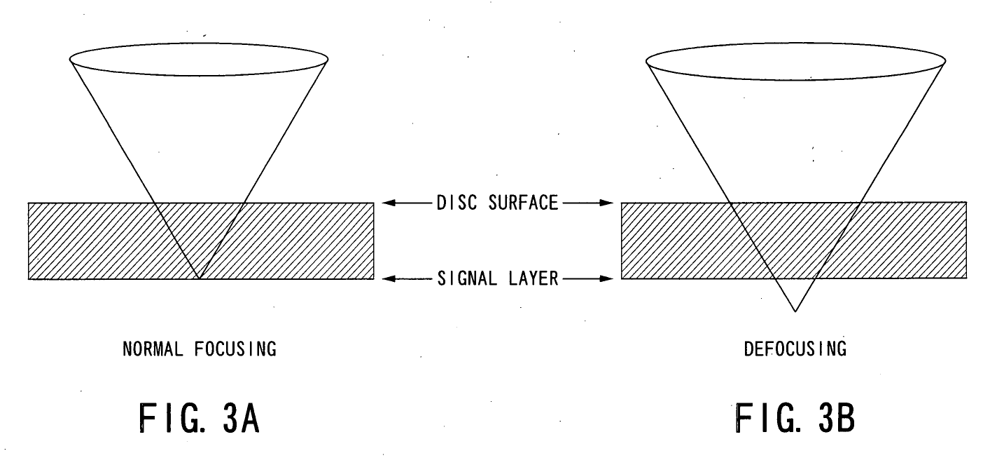

FIGS. 3A and 3B schematically illustrate a defocusing operation. In FIG. 3A shows a focus state according to a conventional manner. A laser light beam output from the optical pickup 2 comes into a focus by an appropriate optical system. Typically, focus control is performed so that the laser light beam focuses on the signal layer of the optical disc 100.

In FIG. 3B shows a defocus state according to the embodiment when a BCA signal is to be reproduced. When a BCA signal is to be reproduced, the RF/BCA selection circuit 10 supplies a control signal for defocus control to the focus control unit 8. The focus control unit 8 performs defocusing by displacing a focus position from the signal layer on the basis of the control signal, as shown in FIG. 3B. As a result, aberration occurs, MTF and a spatial frequency reduce, and thus a high-frequency component can be removed. That is, a laser light beam is applied not at a pinpoint on the signal layer (focus state), but over a predetermined area (defocus state). Accordingly, a window function corresponding to a radiation area is applied to a signal in the signal layer, which is equivalent to a low-pass filter.

If a focus position is changeable, a radiation area on the signal layer is also changeable. As a result, a cutoff frequency of the equivalent low-pass filter can be changed.

The focus position may either be under or above the signal layer for the purpose of equivalently forming a low-pass filter. However, a larger beam spot area on a disc surface is effective for minimizing effects of flaws and dust on the disc surface. In this point of view, the focus position is preferably displaced to under the signal layer so as to be defocused.

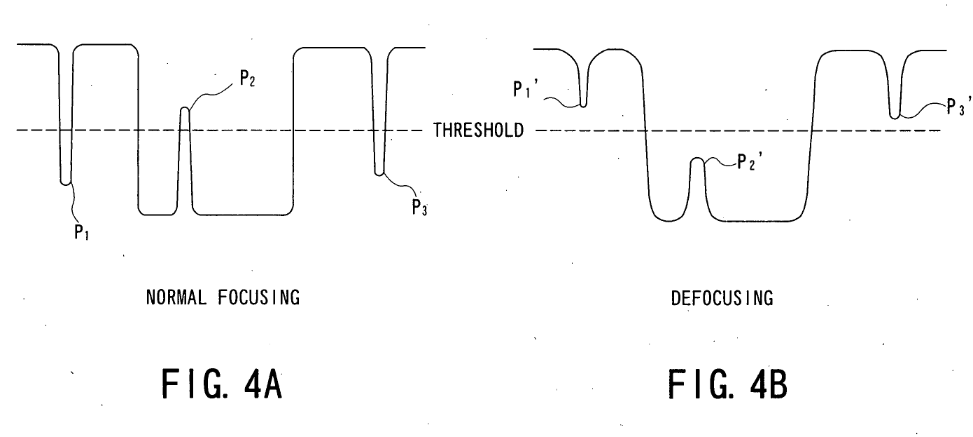

FIGS. 4A and 4B schematically illustrate an effect of defocusing (low-pass filter effect). FIG. 4A shows a waveform obtained in normal focusing. In this waveform, spike noises p1, p2, and p3 cross a threshold, and a wrong signal is read due to these noises. The spike noises occur due to reflected waves from residuals or peeled-off flakes of the reflective film generated when the stripes of the BCA are formed by a laser.

On the other hand, when defocus control is performed, a low-pass filter effect can be obtained. Thus, a waveform of a spike noise becomes less sharp and a peak value decreases, as shown in FIG. 4B. As a result, the noise does not cross the threshold and thus malfunction due to the noise can be prevented.

As described above, in the information reproducing apparatus 1 according to this embodiment, an effect equivalent to a low-pass filter effect can be obtained through defocus control of the optical pickup 2. Accordingly, a low-pass filter, which is a conventionally-required hardware device, need not be provided.

Alternatively, the rotation speed of the spindle motor 3 during reproducing of a BCA signal may be higher than the rotation speed during reproducing of an RF signal (step ST4 in FIG. 2). The preamplifier 41 or the pre-equalizer 42 is provided with a filter (not shown) to allow an RF signal to pass therethrough but cut the higher frequency components. Higher rotation speed of the spindle motor 3 causes an increase in a frequency band of a signal. Accordingly, noise in a relatively high frequency band can be removed without changing the form of the filter to cut high frequency components.

In step ST5 in FIG. 2, the pre-equalizer 42 is set to perform waveform equalization adaptive to a BCA signal. In step ST6, the switch 5 is set to the BCA decoder 7 side.

If a BCA signal is input from the optical pickup 2 under this state, the BCA signal passes through the reproducing system unit 4 shared by an RF signal, and decoded BCA data is output.

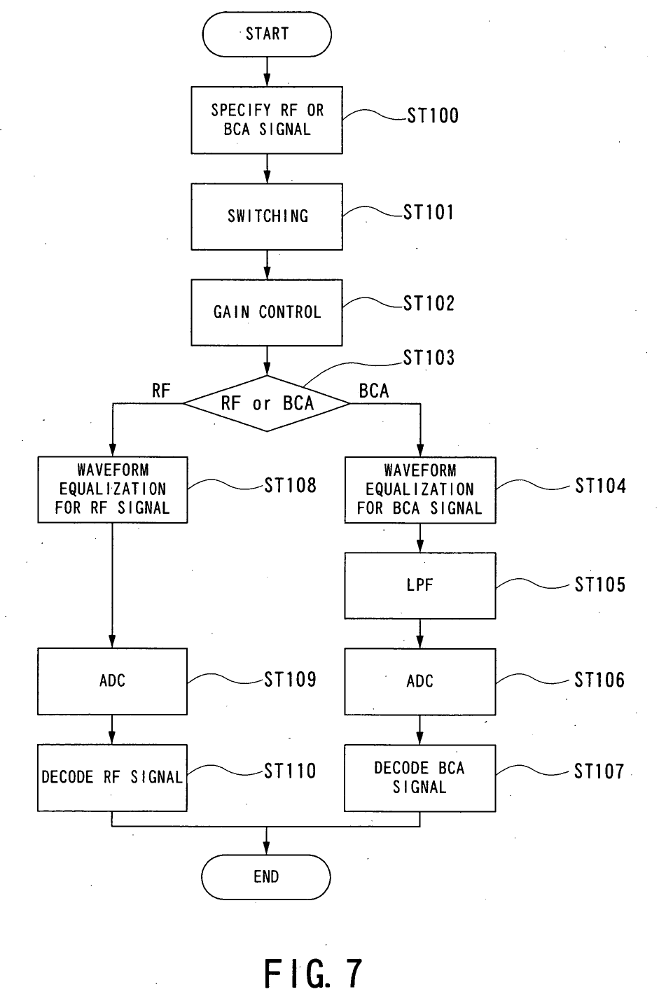

FIG. 7 is a flowchart showing a process performed by the system configuration of the known information reproducing apparatus 200. The process from start to step ST102, where the preamplifier 101 performs gain control, is common to RF and BCA signals. After that, the process branches into a flow of processing an RF signal and a flow of processing a BCA signal. In the flow of processing an RF signal, waveform equalization for an RF signal (step ST108), AD conversion (step ST109), and decoding of the RF signal (step ST110) are sequentially performed.

On the other hand, in the flow of processing a BCA signal, waveform equalization for a BCA signal (step ST104), a LPF process (step ST105), AD conversion (step ST106), and decoding of the BCA signal (step ST107) are sequentially performed.

In the information reproducing apparatus 1 according to this embodiment, an effect equivalent to a low-pass filter effect can be obtained by defocusing. Thus, a low-pass filter, which is a conventionally-required hardware device, need not be provided. Furthermore, a waveform equalization characteristic of the pre-equalizer 42 is changed for each of reproducing of an RF signal and reproducing of a BCA signal, so that two conventionally-required pre-equalizers can be unified.

As a result, the reproducing system from the optical pickup 2 to the ADC 43 can be unified and thus the hardware scale can be reduced.

Further, by increasing the rotation speed of the spindle motor 3 during reproducing of a BCA signal, high-frequency noise components can be further reduced.

(3) Another Embodiment

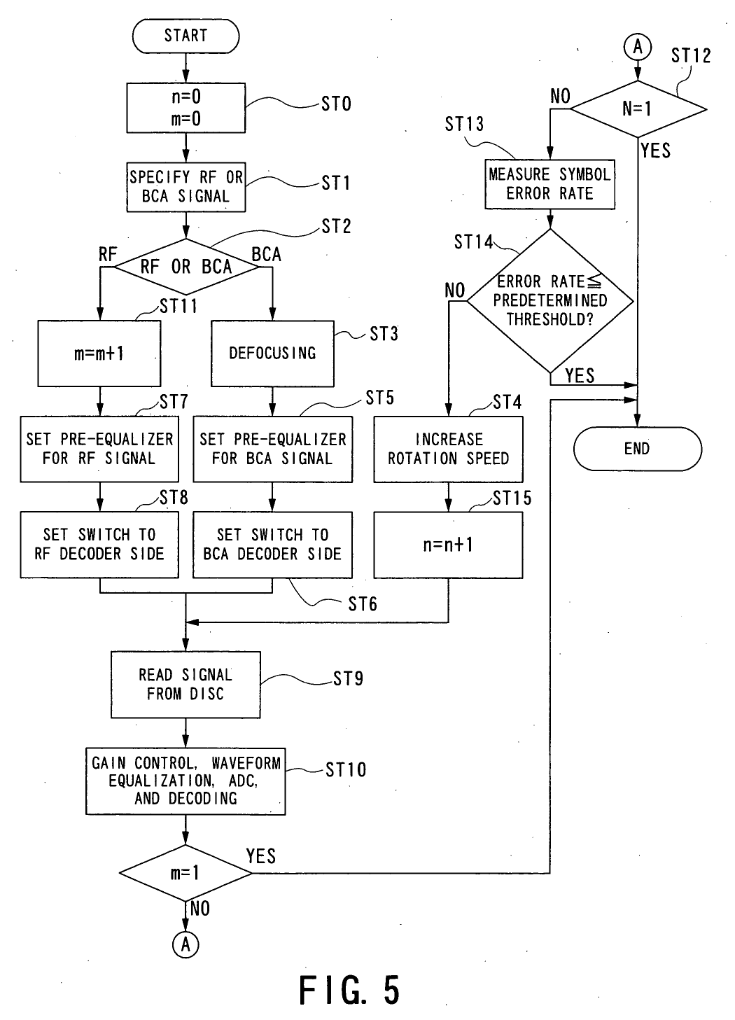

FIG. 5 is a flowchart showing a process according to another embodiment.

In this embodiment, defocus control is performed every time a BCA signal is being reproduced. However, rotation control of the spindle motor is performed only when a measured symbol error rate exceeds a predetermined threshold.

When a BCA signal is to be reproduced, the optical pickup 2 is moved toward the inner side in the thickness direction of the optical disc 100 so as to perform defocusing (step ST3). Then, the pre-equalizer 42 is set for a BCA signal (step ST5) and the switch 5 is set to the BCA decoder 7 side.

The BCA signal is reproduced under this state. At this time, the error measuring unit 11 (see FIG. 1) measures a symbol error rate (step ST13). If the symbol error rate exceeds a predetermined threshold, the rotation speed of the spindle motor 3 is set to a speed higher than a standard speed (step ST4).

As described above, according to this embodiment, a high-frequency component of a BCA signal is removed only by defocusing first. Then, if the BCA signal cannot be read due to noise or the like, the rotation speed of the disc is increased to further remove a high-frequency component.

Otherwise, the rotation speed of the disc may be increased first to reproduce the BCA signal. If the symbol error rate exceeds the predetermined threshold, defocusing of the optical pickup 2 may be performed so as to remove a high-frequency component.

The present invention is not limited to the above-described embodiments, but can be embodied by modifying the elements without deviating from the scope of the present invention. Also, various modifications can be realized by various combinations of a plurality of elements disclosed in the above-described embodiments. For example, some elements among all of the elements described in the embodiments may be deleted. Further, a combination of elements may be made over different embodiments.

What is claimed is:

1. An information reproducing apparatus capable of reproducing an information storage medium storing BCA information recorded in a first area and RF information recorded in a second area on an outer side of the first area, the information reproducing apparatus comprising:
an optical pickup for radiating laser light onto the first and second areas of the information storage medium and detect reflected light thereof;
a reproducing system unit for reproducing an RF signal and a BCA signal on the basis of the reflected light detected by the optical pickup; and
a focus control unit for controlling focusing by setting a focus position of the optical pickup to a signal layer of the optical disc when the RF signal is to be reproduced and control defocusing by displacing the focus position of the optical pickup from the signal layer when the BCA signal is to be reproduced, thereby equivalently suppressing a high-frequency component of the BCA signal.

2. The information reproducing apparatus according to claim 1, wherein the reproducing system unit processes both the RF signal and the BCA signal in the same route from the optical pickup to a digital converter.

3. The information reproducing apparatus according to claim 1, wherein the focus control unit controls defocusing by setting the focus position to a point under the signal layer.

4. The information reproducing apparatus according to claim 1, further comprising:
a rotation control unit for setting a rotation speed of the optical disc to a higher speed than that for reproducing the RF signal when the BCA signal is reproduced.

5. The information reproducing apparatus according to claim 4, further comprising:
an error measuring unit for measuring a symbol error rate of the BCA signal,
wherein the rotation control unit sets the rotation speed to high if the symbol error rate exceeds a predetermined threshold.

6. The information reproducing apparatus according to claim 4, further comprising:
an error measuring unit for measuring a symbol error rate of the BCA signal,
wherein the focus control unit controls defocusing if the symbol error rate exceeds a predetermined threshold.

7. The information reproducing apparatus according to claim 1, wherein the focus control unit is capable of changing the focus position for defocusing, thereby being capable of changing a cutoff frequency to equivalently suppress a high-frequency component of the BCA signal.

8. An information reproducing method capable of reproducing an information storage medium storing BCA information recorded in a first area and RF information recorded in a second area on an outer side of the first area, the information reproducing method comprising the steps of:
radiating laser light onto the first and second areas of the information storage medium and detecting reflected light thereof by an optical pickup;
reproducing an RF signal and a BCA signal on the basis of the reflected light detected by the optical pickup;
controlling focusing by setting a focus position of the optical pickup to a signal layer of the optical disc when the RF signal is to be reproduced; and
controlling defocusing by displacing the focus position of the optical pickup from the signal layer when the BCA signal is to be reproduced, thereby equivalently suppressing a high-frequency component of the BCA signal.

9. The information reproducing method according to claim 8, wherein the step of reproducing processes both the RF signal and the BCA signal in the same route from the optical pickup to a digital converter.

10. The information reproducing method according to claim 8, wherein the step of controlling defocusing controls defocusing by setting the focus position to a point under the signal layer.

11. The information reproducing method according to claim 8, further comprising:
setting a rotation speed of the optical disc to a higher speed than that for reproducing the RF signal when the BCA signal is reproduced.

12. The information reproducing method according to claim 11, further comprising:
measuring a symbol error rate of the BCA signal,
wherein the step of setting sets the rotation speed to high if the symbol error rate exceeds a predetermined threshold.

13. The information reproducing method according to claim 11, further comprising:
measuring a symbol error rate of the BCA signal,
wherein the step of controlling defocusing controls defocusing if the symbol error rate exceeds a predetermined threshold.

14. The information reproducing method according to claim 8, wherein the step of controlling defocusing is capable of changing the focus position for defocusing, thereby being capable of changing a cutoff frequency to equivalently suppress a high-frequency component of the BCA signal.
